(19) United States
(12) Patent Application Publication
(10) Pub. No.: US 2013/0284872 A1
(43) Pub. Date: Oct. 31, 2013

(54) PIPELINE MAT

(71) Applicant: Orain Tubbs, Beaumont, TX (US)

(72) Inventor: Orain Tubbs, Beaumont, TX (US)

(21) Appl. No.: 13/586,197

(22) Filed: Aug. 15, 2012

Related U.S. Application Data
(60) Provisional application No. 61/639,758, filed on Apr. 27, 2012.

(51) Int. Cl. F16L 1/06

(52) U.S. Cl. CPC F16L 1/06
USPC 248/346.02

(57) ABSTRACT

Systems and methods which provide improved pipeline mats are provided herein. Such mats may include one or more of a plurality of the inventive features. For example, some embodiments provide for replaceable top surfaces which allow for portions of the mat to be replaced if in need of repairs, e.g. after excessive wear and tear, rotting, and the like. Further, embodiments may include a built-in air wick channel which allows for airflow to travel between stacked mats, thereby reducing the potential for a mat to rot. Some embodiments may also include a structure which allows for the mat to be moved using a forklift. Such structure may include grouser strips which help direct the forklift while also protecting the top surface from wear. Additionally, such structure may include built-in chocks disposed on the lower surface of the mat. These chocks may also facilitate the air wick channel.

### CROSS-REFERENCE TO RELATED APPLICATIONS

This application claims priority to U.S. Provisional Patent Application No. 61/639,758, filed Apr. 27, 2012 and entitled, “IMPROVED PIPELINE MAT,” the disclosure of which is incorporated herein by reference.

### TECHNICAL FIELD

The present description relates generally to pipeline mats, and more specifically to systems and methods to provide for reusable/durable pipeline mats which are easily transported and deployed.

### BACKGROUND

There are generally two kinds of mats that are used in the pipeline business. One is called a pipeline, crane or bridge mat, which consists of 8 in. by 8 in. timbers, usually six of them bolted together to make a 48 in. by 18 ft. mat. The mat is held together with I-bolts with a tie rod in the end for lifting.

The deficiency with this design is that it is made primarily of wood, such as untreated wood, which comes in contact with the ground and moisture. Once the mats have been used in the field, the wood is generally moist and at that point they are stacked for storage. The moist wood of the mats is stacked together with no little or no air circulation between the units, which usually causes accelerated rot.

In addition, it is difficult to move the stacks of mats, which are generally moved by forklift. There is no gap between the mats to insert the forks of the forklift unless one manually inserts a spacer or chocks between each mat when stacking. These mats are used in large quantities on project sites, and it is not cost effective to have a person manually placing spacers between several thousand mats when stacking for storage.

Another type of mat used in an oilfield is called a laminated mat, constructed of 2 in. by 8 in. boards to make an 6 in. by 8 ft. by 12 or 14 ft. section. There are gaps in between the sections. Again, the mats are constructed almost entirely of wood and have the same drawbacks associated with the other design.

In addition, because the mats are constructed of wood fastened together, one cannot easily repair or replace the individual sections of the mats in the field. Wear from continued use and/or damage from heavy equipment used in the field can cause individual pieces of wood used to construct the mats to disintegrate and fall from the constructed mats. This disintegration causes loss of compression and torque of the tie rods holding the unit together. It also makes the mat no longer useable.

Once compression is lost, the grouser, the teeth on the tracks, will get in between the remaining pieces of the wood and pull the mat apart, thereby destroying the unit. There is no edge protection on the current mats in use, and there is no way to refill or repair the mats in the field. In order to refurbish existing mats, they must first be removed from the oilfield, and then the missing wood may be replaced. This replacement of missing wood generally requires the entire unit to be disassembled prior to repair.

In addition, harder lumber is generally used for laminate pieces of a mat, and softer lumber is used for the interior construction. Once the harder outer lumber is destroyed, the softer inner lumber is also no longer usable. Because of the difficulty and cost of repair, it is not usually cost effective to do so. Thus, mats in need of repair are simply discarded. Generally speaking, one can assume approximately a 40% loss of mats within the first 90-150 days of use in a pipeline project.

### BRIEF SUMMARY

Systems and methods which provide improved pipeline mats are provided herein. Such mats may include one or more of a plurality of the inventive features. For example, some embodiments provide for replaceable top surfaces which allow for portions of the mat to be replaced if in need of repairs, e.g. after excessive wear and tear, rotting, and the like. Further, embodiments may include a built-in air wick channel which allows for airflow to travel between stacked mats, thereby reducing the potential for a mat to rot. Some embodiments may also include a structure which allows for the mat to be moved using a forklift. Such structure may include grouser strips which helped direct the forklift while also protecting the top surface from wear. Additionally, such structure may include built-in chocks disposed on the lower surface of the mat. These chocks may also facilitate the air wick channel.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding, reference is now made to the following descriptions taken in conjunction with the accompanying drawings, in which:

FIG. 1 is an isometric exploded view of a pipeline mat in accordance with the present disclosure;

FIG. 2(a) is a front sectional view of a pipeline mat in accordance with the present disclosure;

FIG. 2(b) is a side sectional view of a pipeline mat in accordance with the present disclosure;

FIG. 3(a) is a plan view of a pipeline mat in accordance with the present disclosure;

FIG. 3(b) is a side view of a pipeline mat in accordance with the present disclosure;

FIG. 4 is a partial exploded view of a pipeline mat in accordance with the present disclosure;

FIG. 5(a) is a plan view of an end cap of a pipeline mat in accordance with the present disclosure;

FIG. 5(b) is a front view of an end cap of a pipeline mat in accordance with the present disclosure;

FIG. 5(c) is a side view of an end cap of a pipeline mat in accordance with the present disclosure;

FIG. 5(d) is an isometric view of an end cap of a pipeline mat in accordance with the present disclosure; and

FIG. 6 is an isometric view of a pipeline mat in accordance with the present disclosure.

### DETAILED DESCRIPTION

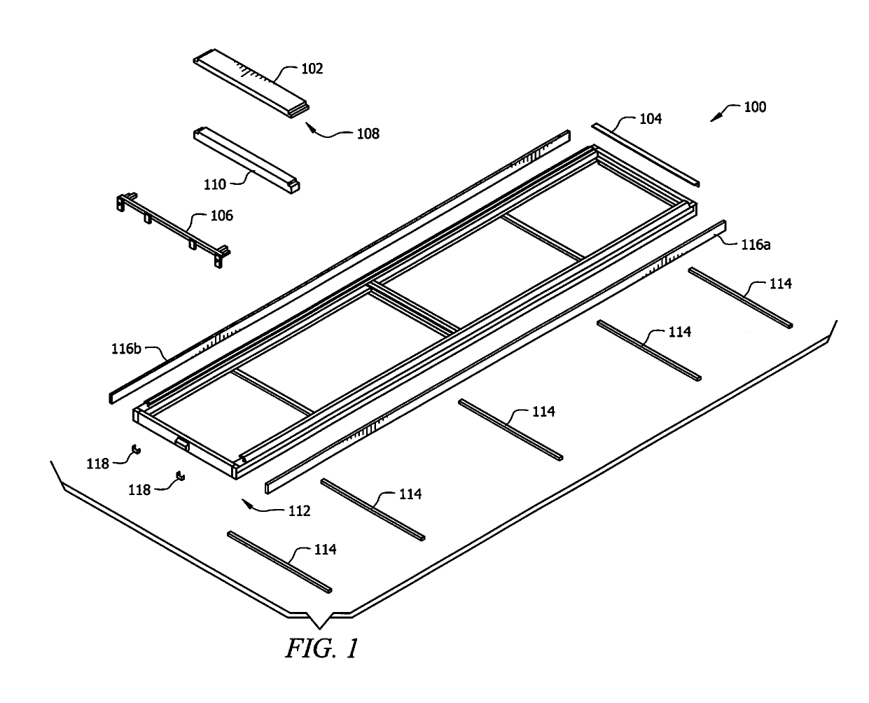

FIG. 1 illustrates an exploded view of a pipeline mat 100 in accordance with an embodiment of the present application. The pipeline mat includes a slidably replaceable top layer material 102. In one embodiment, the top layer material 102 is oak, however other embodiments may include other woods, laminate, or other suitable materials having stronger structural properties to accept the wear from the traffic, heavy equipment, and other materials that come in contact with the mat.

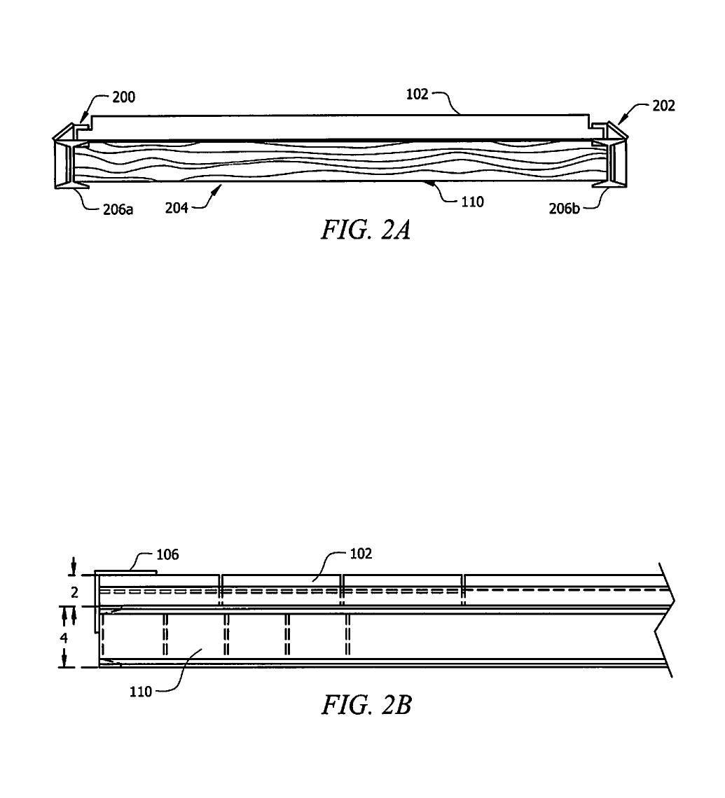

Referring briefly to FIG. 2(a), the top layer material 102 is held in place by an assembly including one or more restraints 200. Returning to FIG. 1, this assembly may also include a back angle piece 104 disposed on one end of the pipeline mat 100, and a removable end cap 106 configured to be disposed on the other end. In some embodiments, the top layer material 102 is not otherwise fastened to the structure, e.g. using bolts, screws, and the like. This assembly allows a user to remove the end cap 106 and easily replace damaged portions of the top layer material 102 while in the at the work site. The top layer material 102 may include extensions 108 on either end. In the present embodiment, an L-shaped extension is shown, which is used for slidably replacing a wooden piece within the assembly of a frame without need to bolt or otherwise fasten the top layer material 102.

In the illustrated embodiment, the end cap 106 is the retainer piece for the top layer material 102. It is bolted to a front portion of the frame for the pipeline mat 100 and holds the edge of the wood in order to keep the wood compressed longitudinally from end to end. To replace damaged top material, the end cap 106 may be removed and the damaged top material may slide out and be replaced.

The pipeline mat 100 also includes a bottom layer material 110. Such a bottom layer material 110 is generally more exposed to the elements while the pipeline mat 100 is in use. This bottom material may be implemented using any material which will provide the structural support necessary to facilitate the functionality of the pipeline mat 100. For example, some embodiments utilize sections of pine which are affixed within the frame of the pipeline mat 100. In some embodiments this bottom section will be permanently attached.

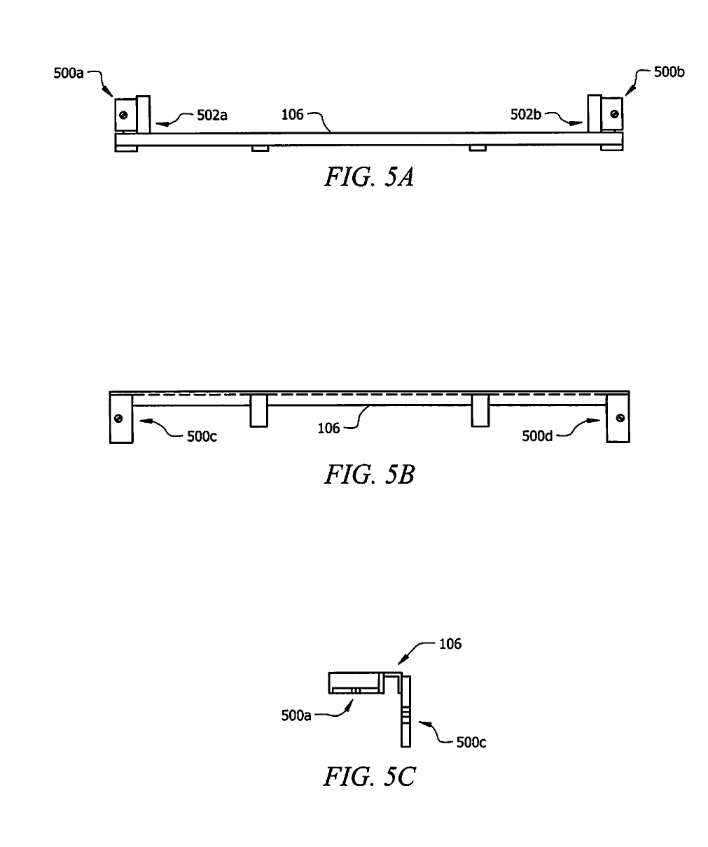

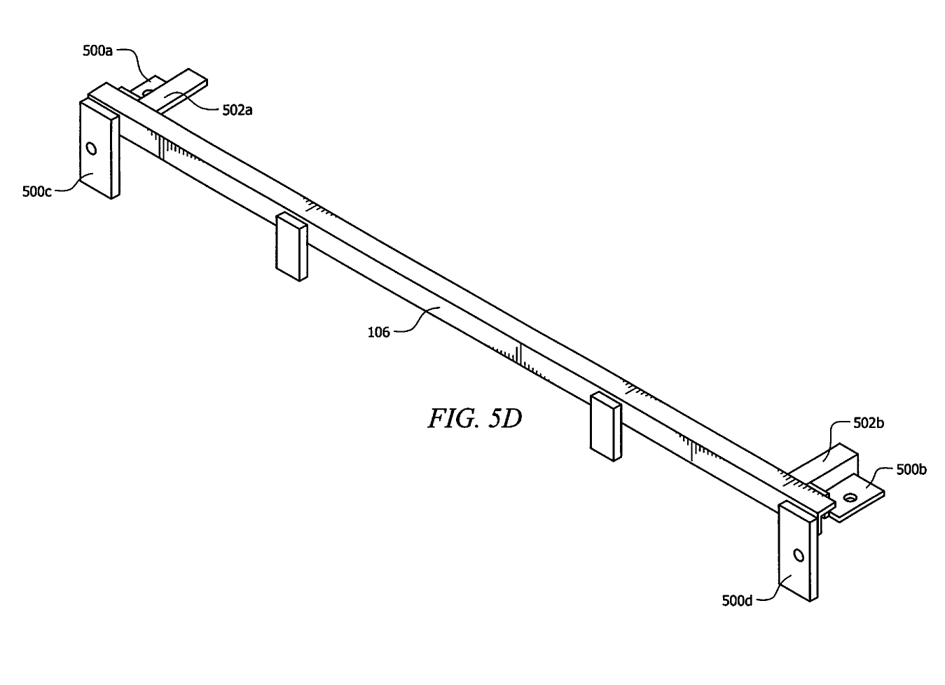

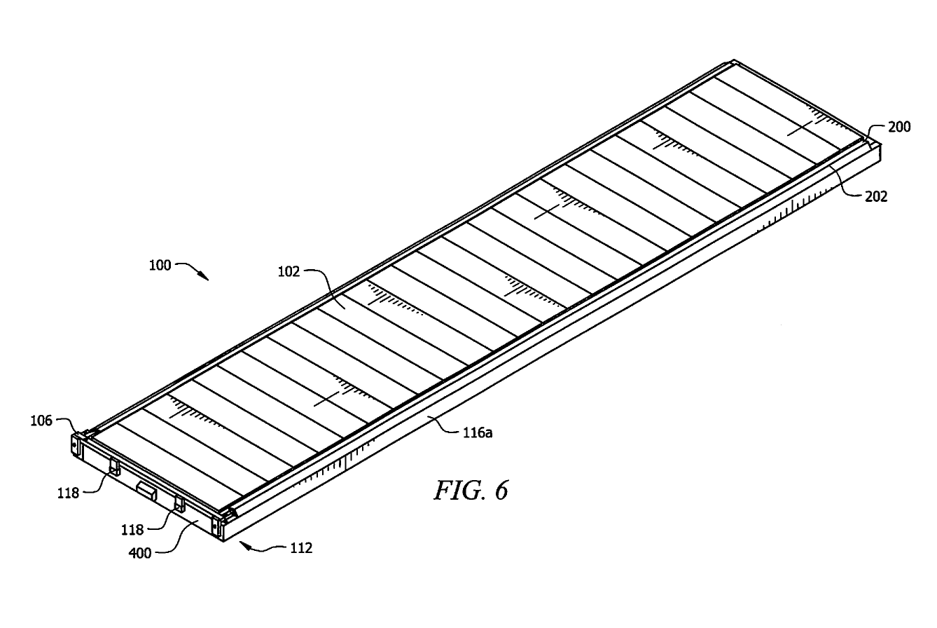

Referring generally to FIGS. 1, 2(a), and 2(b), the pipeline mat frame has a lip portion 112 that is designed to capture the extension 108 from the top layer material 102, and that also connects to the end cap 106. In addition, the frame has an angled piece of metal at each corner which is the mating piece to the top layer material 102, providing the cavity into which the top layer material 102 is inserted. This angled piece of metal is the restraint 200 of the assembly previously mentioned, and may be referred to as a wood restraint in embodiments in which the top layer material 102 is comprised of wood. The restraint 200 may extend continuously along the length of the frame except at the lip portion 112. However, as will be discussed in greater detail below with respect to FIG. 5, extensions of the end cap 106 may be configured to continue or complete the restraint 200.

The frame may also include multiple pieces of guard railing 202, such as flatbar, set at an angle (e.g., approximately 40°). These pieces of guard railing 202 may be attached at an angle to the restraint 200. They may extend continuously along the length of the frame, or in some embodiments, they may extend up to the lip portion 112, where the end cap 106 attaches to the frame. Functionally, these angularly attached pieces of guard railing 202 may serve as an edge protector for the pipeline mat (e.g., protecting the edge of the top layer material 102).

In one aspect, the edge protector (e.g., guard railing 202 and/or restraint 200) serves as a grouser wear strip. For example, when the mat 100 is in use at the work site, multiple mats are typically placed side by side in an array 18 ft. wide. The length of the array is dictated by the requirements of the work site. When a tracked vehicle (grouser) approaches the array of mats, the tracks of the vehicle will often damage the material at the edge of the exposed mat. In accordance with the present disclosure, the restraint 200 of the metal frame, as well as the provided guard railing 202, may be utilized to provide protection from this damage. As configured, the wood restraint 202 provides a structural support for the guard railing 202 to deflect the grouser from the edges of the wooden portions of the mat 100.

In another aspect, the edge protector serves as a fork slide to allow the forks of a forklift to be easily slid between two stacked mats for transport. For example, when the forks are inserted between two mats, they contact the edge protector and are deflected upwards into an upper half of an air wick channel 204 provided on an underside of the upper one of the mats. Together, the forkslide and air wick channel substantially prevent the forks from directly contacting the wood of the bottom layer material. This configuration facilitates sliding of one or more forks of a forklift into the open space between a plurality of mats, which are stacked upon each other, in order to lift one or more mats.

In contrast, prior art mats are unable to be moved by forklift without the use of further components, such as spacers, because of the design as mentioned above. Existing mats are moved by a squeeze clamp attached to a track hoe, which clamps individual mats by the ends using friction compression and places them on the ground where needed. The difficulty with moving mats using this method is that only a single mat may be moved at a time. The mats of the present disclosure may individually be moved by this existing method, or one or more mats may be moved by forklift, which provides a significant time and cost savings to the user.

In the embodiment shown in FIG. 2(a), the bottom layer material 110 is held in place by S-beams 206A and 206B, which are similar to I-beams, but have flanges tapered at the top and bottom. The guard railing 202 may be angularly attached to the S-beams 206A and 206B, as well as to the restraint 200. In some embodiments, welding may be utilized to attach the restraint 200 to the S-beams 206A and 206B, and also to attach the guard railing 202 to the restraint 200 and the S-beams 206A and 206B. It should be noted that the frame is comprised of the S-beams 206A and 206B, and that side cap plates 116A and 116B, as shown in FIG. 1, may be provided to the S-beams to prevent forks of a fork lift from being misdirected or caught by outer tapered flanges of the S-beams 206A and 206B. The use of the S-beams 206A and 206B creates the air wick channel 204 at the bottom of the mat 100, and keeps the flat, lower surface of the bottom layer material 110 from direct contact with other mats when stacked. The tapered flanges engage extensions of the bottom layer material 110 that are configured to fit within a recess formed between the tapered flanges while permitting the upper surface of the bottom layer material to extend upwards and provide structural support for the top layer material during use. These extensions may be L-shaped, but other shapes are also contemplated, such as smoothly tapered extensions that match the tapers of the upper tapered flanges of the S-beams 206A and 206B. The tapered flanges function to retain a lower surface of the bottom layer material at a height above a bottom of the mat, thereby forming the air wick channel 204. This configuration allows air flow and prevents rot caused by surfaces of wet boards directly contacting one another during storage. It should be understood that other embodiments are not limited to a particular structure, such as an S-beam, but may utilize any structure that provides the advantages of retaining the bottom layer material and providing spacing to create the air wick channel.

In addition, metal pieces, such as the flat bar metal supports shown in FIG. 1, and referred to herein as chocks 114, are fastened (e.g., welded, bolted, or riveted) to the bottom of the mat 100 to create an additional space underneath the bottom layer material 110. In this manner, when multiple mats are stacked, air can freely flow between the units and allow the wood to dry between uses. This spacing apart of the mats also facilitates use a forklift to transport multiple mats. These chocks 114 also serve to provide traction or grip for the mats when in use, so that the mats do not slip against the ground underneath the grousers. It should be understood that the chocks 114 are not limited to flat bar metal supports, but may be composed of any structure that creates additional spacing for stored mats, and provides traction or grip for mats during use.

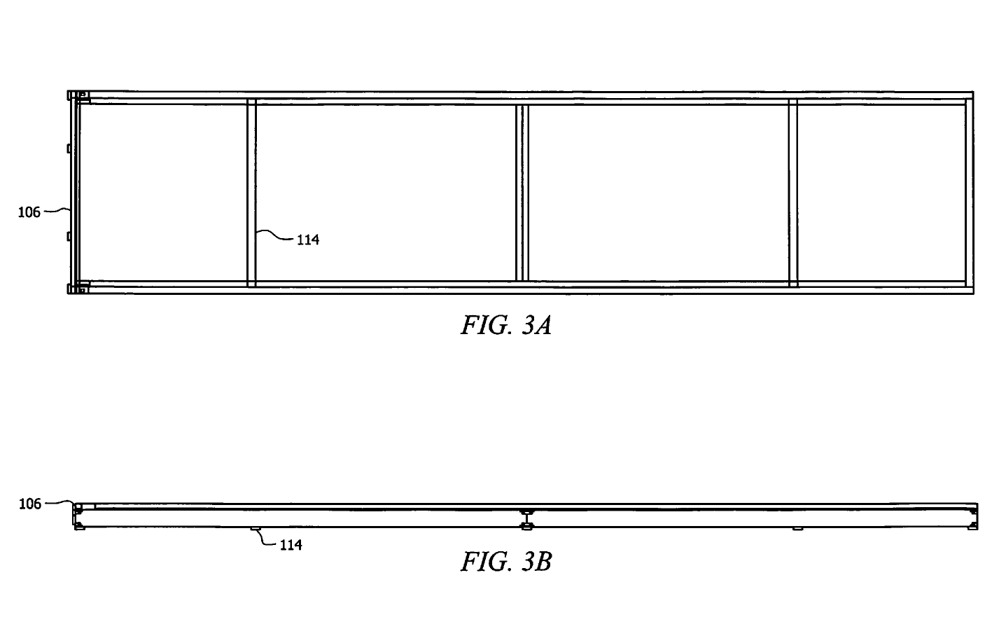

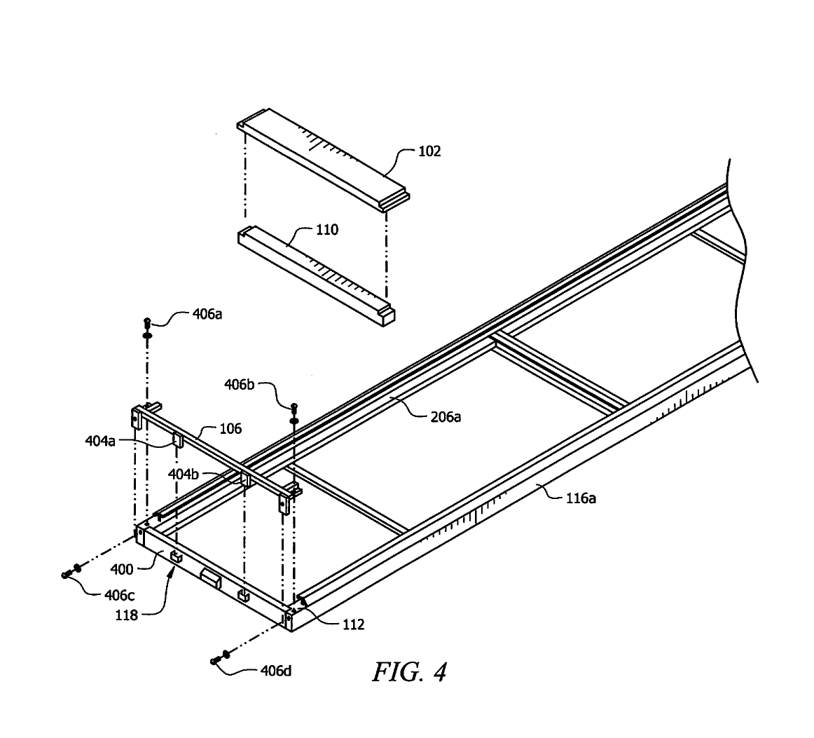

Referring now to FIG. 3, FIG. 3(a) and FIG. 3(b) respectively illustrate a top and a side view of the mat 100 shown in FIG. 1. FIG. 3(b) provides a side view of the chassis without the top and bottom material in order to demonstrate placement of the chocks 114, some of which are partially obstructed in FIG. 3(a). The chocks 114 may have a height, such as ¼ or ½ of an inch. However, additional or alternative embodiments may utilize any size of chocks 114 while implementing the inventive aspects of the present disclosure. For example ¾ or even 1 inch chocks may be used. In fact, various design considerations, such as different materials being used, may lend themselves to utilizing different heights. It is noted that ½ inch chocks 114 are more readily available on the market at the current time.

FIG. 4 is a zoomed in exploded view of the embodiment of FIG. 1. FIG. 4 illustrates that the end cap 106 is removable. As can be seen, the top layer material 102 may be slidably inserted into the frame over the bottom layer material 110. Upon insertion of the pieces of the top layer material 102, the removable end cap 106 and may be reattached to the frame at the lip portion 112 thereof in order to secure the pieces of top layer material 102 in place. The lip portion 112 may be comprised of end portions of the S-beams 206A and 206B, a front side 400 of the frame, and a pair of horizontal, spaced apart slots, referred to herein as end cap pockets 118, provided to the front side 400 of the frame. Spaced apart vertical members 404A and 404B of the end cap 106 may be configured to insert into these slots in order to facilitate positioning and retention of end cap 106 in a removable fashion. Fasteners 406A-406D may be implemented in any manner suitable for securing the end cap 106 to the frame at the lip portion 112. In the illustrated embodiment, fasteners 406A-406D are shown as bolts. Fasteners 406A-406D may be used to secure apertured extension flanges of the end cap 106 to the frame through apertures formed in the lip portion 112 at top surfaces of the S-beams 206A and 206B, and at recessed edges of the front side 400 of the frame.

Referring generally to FIG. 5(a)-FIG. 5(d), multiple extension flanges 500A-500D facilitate secure fitting of the end cap 106 with the pipeline mat. For example, the illustrated embodiment includes flanges 500A-500B on both ends which allow for the end cap 106 to be bolted onto a top of the mat. The illustrated embodiment also shows flanges 500C-500D extending downward from the front surface which are to be received on the front side of the mat, which may assist in securing the end cap onto the pipeline mat. Additionally, the end cap 106 may be provided with extensions 502A and 502B that may be configured to effectively continue or complete the wood restraint for the lip portion of the frame.

It is noted that embodiments of the present application are not limited to any specific implementation of an end cap 106, including any manner to attach or remove the end cap 106. It is appreciated that the end cap 106 functions to retain the slidably replaceable top material. As such, an end cap 106 can be constructed in any manner to accomplish these ends. It is further noted that embodiments may utilize different structure to secure the top material. Such structure does not necessarily have to be located at the end of a mat. The invention is not necessarily limited to the particular end cap design illustrated in the figures. All that is required is a removable or repositionable piece to secure the top material and facilitate replacement thereof.

FIG. 6 shows a completely assembled pipeline mat 100 in accordance with one embodiment of the present application. As shown in FIG. 6, the top layer material 102 includes a plurality of beams which are utilized to form the top surface. The end cap 106 is inserted into end cap pockets 118 on the front side 400 of the frame and bolted to the lip portion 112 of the frame of the mat 100 to longitudinally secure the top beams. The L-shaped portions of the top surface are locked down by the restraint 200 that traverses the length of the mat. Further, FIG. 6 illustrates the angled guard railing 202 that serves as a fork slide that facilitates forklift transportation, and that also functions as a grouser wear strip when the mat is actually in use. Notably, the flat bar 202 may be discontinuous at the lip portion 112 of the frame to facilitate access to the bolts securing the end cap 106 to the frame. The L-shaped portion of the top surface allows the grouser wear strip to be attached or welded to the restraint 200, and helps protect the edge of the wood from direct contact with the grouser to avoid damage. Side cap plate 116A covers outer tapered flange regions of the S-beams and function to prevent forks of a fork lift from being caught or misdirected by the outer tapered flanges.

Although the present invention and its advantages have been described in detail, it should be understood that various changes, substitutions and alterations can be made herein without departing from the spirit and scope of the invention. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the claims which issue from this application are intended to include within their scope such processes, machines, manufacture, compositions of matter, means, methods, or steps.

What is claimed is:

1. A pipeline mat, comprising;
top layer material having extensions therefrom;
bottom layer material;
a frame enclosing the bottom layer material and having restraints configured to engage the extensions of the top layer material; and
an end cap removably attachable to the frame at an end thereof to longitudinally retain the top layer material within the restraints.

2. The pipeline mat of claim 1, wherein the top layer material is at least partially comprised of at least one of wood or synthetic material.

3. The pipeline mat of claim 1, wherein the extensions of the top layer material are L-shaped extensions.

4. The pipeline mat of claim 1, wherein the bottom layer material is at least partially comprised of treated pine.

5. The pipeline mat of claim 1, wherein the frame is configured to retain a lower surface of the bottom layer material at a distance above a bottom of the mat, thereby forming an air wick channel.

6. The pipeline mat of claim 5, wherein the frame includes S-beams having tapered flanges configured to engage the bottom layer material and retain the lower surface of the bottom layer material at the distance above the bottom of the mat.

7. The pipeline mat of claim 6, wherein the bottom layer material has extensions therefrom configured to engage recesses formed by the tapered flanges of the S-beams.

8. The pipeline mat of claim 5, wherein the restraints are configured as angled pieces attached to upper surfaces of the S-beams.

9. The pipeline mat of claim 8, wherein the frame has an edge protector that protects an edge of the top layer material.

10. The pipeline mat of claim 9, wherein the edge protector includes a guard railing angularly attached to the S-beams and the restraints.

11. The pipeline mat of claim 6, wherein the frame further comprises:
one or more side cap plates configured to cover outer tapered flanges of the S-beams.

12. The pipeline mat of claim 1, wherein the frame has a back angle piece attached at another end of the frame opposite the end at which the end cap is removably attachable.

13. The pipeline mat of claim 1, wherein the frame has a front side provided with one or more end cap pockets configured to receive one or more vertical members of the end cap.

14. The pipeline mat of claim 1, wherein the end cap has one or more apertured flanges, the frame has an apertured lip portion at the end of the frame at which the end cap is removably attachable, and the restraints are discontinuous at the apertured lip portion of the frame.

15. The pipeline mat of claim 1, wherein the frame includes one or more supports fastened to the bottom of the mat to create a space underneath the bottom layer material.

16. A pipeline mat, comprising:
top layer material;
bottom layer material;
a frame having an edge protector that protects an edge of the top layer material.

17. The pipeline mat of claim 16, wherein the top layer material is at least partially comprised of wood or synthetic materials.

18. The pipeline mat of claim 16, wherein the bottom layer material is at least partially comprised of pine.

19. The pipeline mat of claim 16, wherein the top layer material has extensions therefrom, and the frame has restraints configured to engage the extensions of the top layer material.

20. The pipeline mat of claim 19, wherein the frame includes S-beams having tapered flanges configured to engage the bottom layer material and retain a lower surface of the bottom layer material at the distance above the bottom of the mat, thereby forming an air wick channel.

21. The pipeline mat of claim 20, wherein the edge protector includes a guard railing angularly attached to the S-beams and the restraints.

22. The pipeline mat of claim 20, wherein the bottom layer material has extensions therefrom configured to engage recesses formed by the tapered flanges of the S-beams.

23. The pipeline mat of claim 20, wherein the restraints are configured as angled pieces attached to upper surfaces of the S-beams.

24. The pipeline mat of claim 20, wherein the frame includes one or more side cap plates configured to cover outer tapered flanges of the S-beams.

25. The pipeline mat of claim 19, wherein the extensions of the top layer material are L-shaped extensions.

26. The pipeline mat of claim 19, further comprising:
an end cap removably attachable to the frame at an end thereof to longitudinally retain the top layer material within the restraints.

27. The pipeline mat of claim 26, wherein the frame has a back angle piece attached at another end of the frame opposite the end at which the end cap is removably attachable.

28. The pipeline mat of claim 26, wherein the frame has a front side provided with one or more end cap pockets configured to receive one or more vertical members of the end cap.

29. The pipeline mat of claim 26, wherein the end cap has one or more apertured flanges, the frame has an apertured lip portion at the end of the frame at which the end cap is removably attachable, and the restraints are discontinuous at the apertured lip portion of the frame.

30. The pipeline mat of claim 16, wherein the frame includes one or more supports fastened to the bottom of the mat to create a space underneath the bottom layer material.

31. A pipeline mat, comprising:
top layer material;
bottom layer material;
a frame enclosing the bottom layer material and configured to retain a lower surface of the bottom layer material at a distance above a bottom of the mat, thereby forming an air wick channel.

32. The pipeline mat of claim 31, wherein the top layer material is at least partially comprised of oak.

33. The pipeline mat of claim 31, wherein the bottom layer material is at least partially comprised of pine.

34. The pipeline mat of claim 30, wherein the frame includes one or more supports fastened to the bottom of the mat to create an additional space underneath the bottom layer material.

35. The pipeline mat of claim 31, wherein the frame includes S-beams having tapered flanges configured to engage the bottom layer material and retain the lower surface of the bottom layer material at the distance above the bottom of the mat.

36. The pipeline mat of claim 35, wherein the top layer material has extensions therefrom, and the frame has restraints configured to engage the extensions of the top layer material.

37. The pipeline mat of claim 36, wherein the frame has an edge protector configured to protect an edge of the top layer material.

38. The pipeline mat of claim 37, wherein the edge protector includes a guard railing angularly attached to the S-beams and the restraints.

39. The pipeline mat of claim 37, wherein the restraints are configured as angled pieces attached to upper surfaces of the S-beams.

40. The pipeline mat of claim 36, further comprising:
an end cap removably attachable to the frame at an end thereof to longitudinally retain the top layer material within the restraints.

41. The pipeline mat of claim 40, wherein the frame has a back angle piece attached at another end of the frame opposite the end at which the end cap is removably attachable.

42. The pipeline mat of claim 40, wherein the frame has a front side provided with one or more end cap pockets configured to receive one or more vertical members of the end cap.

43. The pipeline mat of claim 40, wherein the end cap has one or more apertured flanges, the frame has an apertured lip portion at the end of the frame at which the end cap is removably attachable, and the restraints are discontinuous at the apertured lip portion of the frame.

44. The pipeline mat of claim 35, wherein the bottom layer material has extensions therefrom configured to engage recesses formed by the tapered flanges of the S-beams.

45. The pipeline mat of claim 35, wherein the frame includes one or more side cap plates configured to cover outer tapered flanges of the S-beams.
